(19) United States
(12) Patent Application Publication
(10) Pub. No.: US 2007/0206850 A1
(43) Pub. Date: Sep. 6, 2007

(54) Color processing system and method for converting display colors of an image data into printing colors

(75) Inventors: Yih-Chin Lin, Taipei (TW); Che-Hung Hu, Taipei (TW)

Correspondence Address: TROXELL LAW OFFICE PLLC, SUITE 1404, 5205 LEESBURG PIKE, FALLS CHURCH, VA, 22041, US

(73) Assignee: Destiny Technology Corporation

(21) Appl. No.: 11/366,572

(22) Filed: Mar. 3, 2006

(51) Int. Cl. G06K 9/00

(52) U.S. Cl. 382/162

(57) ABSTRACT

A color processing system includes a storage memory stored with several pieces of reference data corresponding to display colors and printing colors respectively, a cache, and a CMM (color management module) for converting display colors of an image data into color regions having the printing colors. The CMM includes a data capture module and a color match module. The data capture module is electrically coupled to the storage memory and the cache. The color match module is electrically coupled to the data capture module. The color match module can capture display colors of an image data from an exterior thereof and a piece of reference data corresponding to the display colors from the cache via the data capture module. The captured display colors of the image data are converted by the color match module into color regions having the printing colors.

### FIELD OF THE INVENTION

The invention relates to a color processing system and method, more particularly to a color processing system that uses a color management module for managing a storage memory for converting display colors of an image data into printing colors and the color converting method thereof.

### BACKGROUND OF INVENTION

When it is desired to print an image data on a piece of paper by a printing device, a color processing system enables the image data to undergo a color conversion process. Thus, the display colors (basic R, G, B colors of light) of the image data are firstly converted into CMYK (cyan, magenta, yellow and black) printing colors prior to being printed, and secondly the image data is printed in the CMYK colors in the overlap manner so that the finished product (or printout) may have CMYK colors.

FIG. 1 shows a block diagram representing a conventional color processing system 2, and includes a storage memory 4 and a color management module 6. Pluralities of reference data 402 corresponding to the display colors and the printing colors are stored within the storage memory 4 in advance. The color management module 6 is electrically coupled to the storage memory 4. After capturing the R, G, B colors of an image data from an exterior, the color management module 6 will capture from the storage memory 4 a piece of reference data 402 corresponding to the captured RGB colors in order to convert the latter into CMYK printing colors.

Note that the storage memory 4 in the conventional color processing system 2 is a non-volatile memory. The data transmission between the color management module 6 and the storage memory 4 is relatively slow, i. e. the color management module 6 is required to conduct a comparing action upon receipt of each image data with respect to each and everyone of those reference data 402 stored within the storage memory 4 in order to find out the respective reference data, thereby resulting in a relatively long processing time and hindering the color conversion process.

### SUMMARY OF THE INVENTION

The main object of the present invention is to provide a color processing system that uses a color management module for converting the display colors of an image data into color regions having the printing colors so as to upgrade the ability of a printing device.

In one aspect of the present invention, a color converting method is proposed for converting display colors of an image data into corresponding printing colors, several pieces of reference data corresponding to the display colors and the printing colors being stored in a storage memory, the color converting method includes the steps: capturing the display colors of the image data from an exterior thereof; determining whether a piece of reference data corresponding the captured display colors is located within a cache; converting the captured display colors of the image data into color regions having the printing colors in case the piece of reference data corresponding to the captured display colors is present within the cache; turning to the storage memory in order to capture the piece of reference data corresponding to the captured display colors in case the piece of reference data corresponding to the captured display colors is absent from the cache; and

storing the piece of reference data corresponding to the captured display colors in the cache in order to facilitate conversion of the captured display colors of the image data into the color regions having the printing colors.

In a second aspect of the present invention, a color processing system is proposed and includes: a storage memory stored with several pieces of reference data corresponding to display colors and printing colors respectively: a cache; a CMM (color management module) for converting display colors of an image data into color regions having the printing colors, the CMM including a data capture module and a color match module, wherein the data capture module is electrically coupled to the storage memory and the cache while the color match module is electrically coupled to the data capture module, the color match module capable of capturing display colors of an image data from an exterior thereof and a piece of reference data corresponding to the display colors from the cache via the data capture module, in case the piece of reference data corresponding the captured display colors being located within the cache, the captured display colors of the image data are converted by the color match module into color regions having the printing colors; and wherein, in case the piece of reference data corresponding to the captured display colors is absent from the cache, the direction thereof is turned to the storage memory in order to capture the piece of reference data corresponding to the captured display colors so as to store the piece of reference data in the cache in order to facilitate conversion of the captured display colors of the image data into the color regions having the printing colors.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a block diagram illustrating how a conventional color processing system converts display colors into printing colors;

FIG. 2 is a block diagram representing a color processing system of the present invention;

FIG. 3 illustrates the steps how the display colors of an image data is converted into the printing colors in the color processing system of the present invention; and

FIG. 4 illustrates the further steps how a cache employed in the color processing system of the present invention determines whether a piece of reference data corresponds to the display colors of the image data.

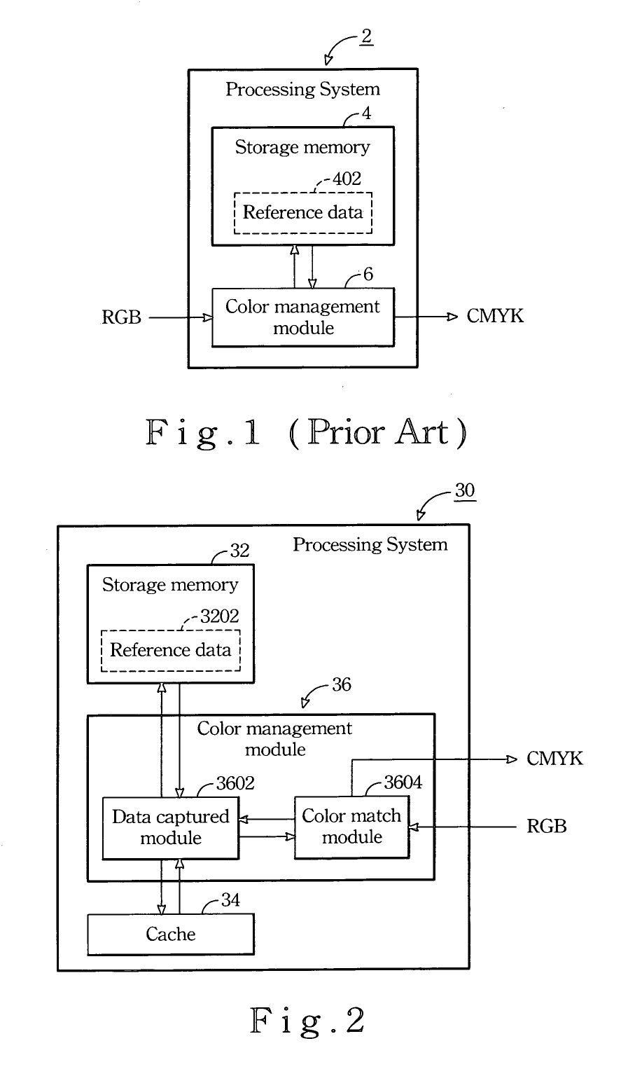

### DETAILED DESCRIPTIONS OF THE PREFERRED EMBODIMENT

FIG. 2 illustrates a block diagram representing a color processing system 30 of the present invention is used for converting the R, G, B colors of an image data into the corresponding CMYK (cyan, magenta, yellow and black) colors for printing on a piece of paper. The color processing system 30 accordingly includes a storage memory 32, a cache 34 and a color management module 36.

The cache 34 is as a matter of fact a non-volatile memory within which several pieces of reference data 3202 are stored in advance. The pieces of reference data 3202 are corresponding to the display colors and the printing colors respectively.

The color management module (CMM) 36 is used for converting the display colors (R,G,B colors) into color regions having the printing colors (CMYK colors) prior to the printing operation. The CMM 36 includes a data capture module 3602 and a color match module 3604, wherein the data capture module 3602 is electrically coupled to the storage memory 32 and the cache 34. The cache 34 can best be a volatile memory, such as a D flip-flop or a SRAM (static random access memory).

The color match module 3604 is electrically coupled to the data capture module 3602. The color match module 3604 is capable of capturing display colors of an image data from an exterior thereof and a piece of reference data corresponding to the display colors from the cache 34 via the data capture module 3602.

In case the piece of reference data 3202 corresponding the captured display colors is located within the cache 34, the captured display colors (RGB) of the image data are converted by the color match module 3604 into color regions having the printing colors (CMYK).

In case the piece of reference data 3202 corresponding to the captured display colors (RGB) is absent from the cache 34, the capturing direction is turned towards the storage memory 32 in order to capture the piece of reference data 3202. Under this condition, the piece of reference data 3202 can be stored within the cache 34 in order to facilitate conversion of the captured display colors (RGB) of the image data into the color regions having the printing colors (CMYK).

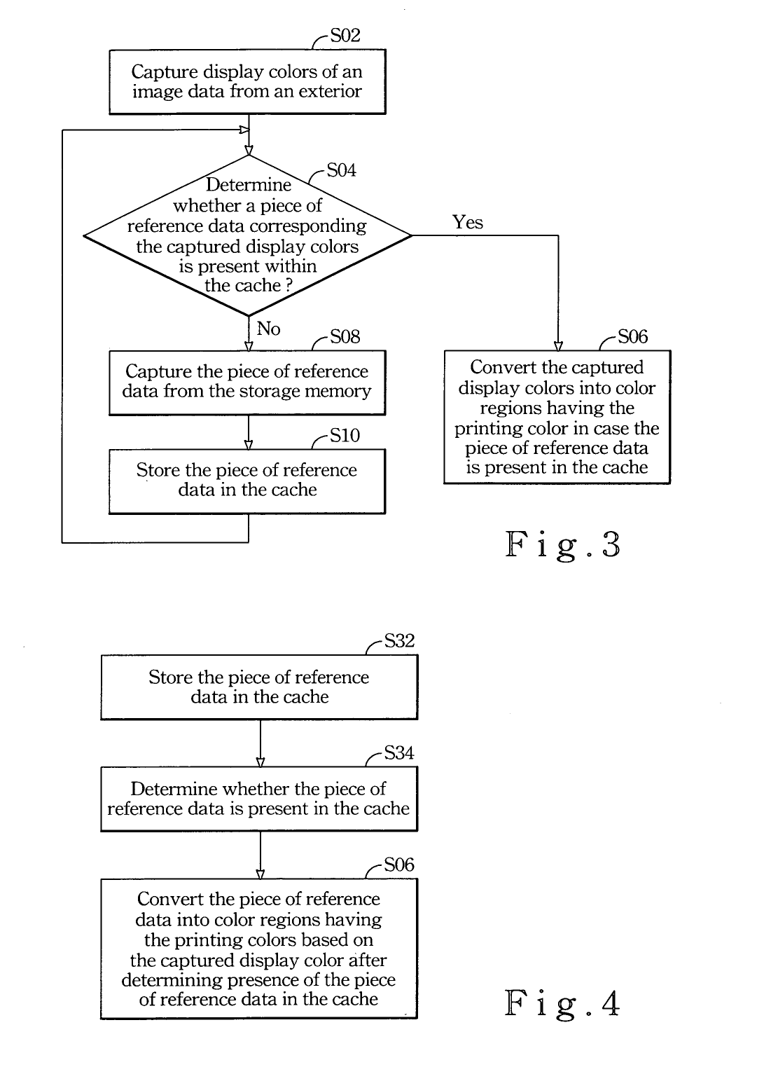

FIG. 3 shows the steps of the color converting method illustrating how the display colors of an image data are converted into the printing colors in the color processing system of the present invention. The storage memory 32 is preferably a non-volatile memory that is stored in advance with several pieces of reference data 3202 corresponding to the display colors and the printing colors.

In step S02, the display colors of the image data are captured from an exterior thereof.

In step S04, find out or determine whether a piece of reference data 3202 corresponding the captured display colors is located within the cache 34. The cache 34 can be a volatile memory, such as a D flip-flop or a SRAM (static random access memory). In case the piece of reference data 3202 corresponding to the captured display colors is present within the cache 34, the captured display colors (R, G, B) of the image data are converted into color regions having the printing colors (CMYK), according to the step S06.

In step S08, in case the piece of reference data 3202 corresponding to the captured display colors (R,G,B) is absent from the cache 34, the capturing direction is turned towards the storage memory 32 in order to capture the piece of reference data 3202 therefrom.

In step S10, the piece of reference data 3202 corresponding to the captured display colors is stored within the cache 34 in order to facilitate conversion of the captured display colors (R,G,B) of the image data into the color regions having the printing colors (CMYK).

Referring to FIG. 4, the color converting method further includes (after determining presence of the piece of reference data 3202 corresponding to the captured display colors in the cache 34) the step S32, the piece of reference data 3202 is captured directly from the cache 34 and the step 34, determine whether the piece of reference data 3202 is correspond to the captured display colors of the image data. In case the piece of reference data 3202 is correspond to the captured display colors, then the piece of reference data 3202 is converted into the color regions having the printing colors based on the captured display colors. The image data is printed out according to the step S06, and therefore the final product (the printout) has CMYK colors.

To summarize the above paragraphs, it is observable that since the CMM is used for capturing the piece of reference data 3202 from the cache 34, the capturing time is shorten when compared to the prior art capturing time, which, in turn, results in quick color conversion of the image data. Therefore, the printing performance of the printing device provided with the color processing system of the present invention is consequently upgraded.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A color converting method for converting display colors of an image data into corresponding printing colors, several pieces of reference data corresponding to the display colors and the printing colors being stored in a storage memory, the color converting method comprising:
capturing the display colors of the image data from an exterior thereof;
determining whether a piece of reference data corresponding said captured display colors is located within a cache;
converting said captured display colors of the image data into color regions having the printing colors in case said piece of reference data corresponding to said captured display colors is present within the cache;
turning to the storage memory in order to capture said piece of reference data corresponding to the captured display colors in case said piece of reference data corresponding to said captured display colors is absent from the cache; and
storing said piece of reference data corresponding to said captured display colors in the cache in order to facilitate conversion of said the captured display colors of the image data into said color regions having the printing colors.

2. The color converting method according to claim 1, wherein the cache is a volatile memory.

3. The color converting method according to claim 2, wherein the cache is a D flip-flop.

4. The color converting method according to claim 2, wherein the cache is a SRAM (static random access memory).

5. The color converting method according to claim 1, wherein the cache is a non-volatile memory.

6. The color converting method further comprising the steps of, after determining presence of said piece of reference data corresponding to said captured display colors in the cache:
capturing said piece of reference data from the cache;
determining whether said piece of reference data is correspond to said captured display colors of the image data; and
converting said piece of reference data into the color regions having the printing colors based on the captured display colors in case said piece of reference data is correspond to said captured display colors.

7. The color converting method according to claim 1, wherein the printing device further includes a CMM (color management module), said converting operation being performed by said CMM.

8. A color processing system comprising:
a storage memory stored with several pieces of reference data corresponding to display colors and printing colors respectively:
a cache;
a CMM (color management module) for converting display colors of an image data into color regions having the printing colors, said CMM including a data capture module and a color match module, wherein said data capture module is electrically coupled to said storage memory and said cache while said color match module is electrically coupled to said data capture module, said color match module capable of capturing display colors of an image data from an exterior thereof and a piece of reference data corresponding to said display colors from said cache via said data capture module, in case said piece of reference data corresponding said captured display colors being located within said cache, said captured display colors of the image data are converted by said color match module into color regions having the printing colors; and
wherein, in case said piece of reference data corresponding to said captured display colors is absent from said cache, the direction thereof is turned to the storage memory in order to capture said piece of reference data corresponding to the captured display colors so as to store said piece of reference data in said cache in order to facilitate conversion of said captured display colors of the image data into the color regions having the printing colors.

9. The color processing system according to claim 8, wherein said cache is a volatile memory.

10. The color processing system according to claim 9, wherein said cache is a D flip-flop.

11. The color processing system according to claim 9, wherein said cache is a SRAM (static random access memory).

12. The color processing system according to claim 8, wherein said cache is a non-volatile memory.
